(19) United States
(12) Patent Application Publication
(10) Pub. No.: US 2019/0062044 A1
(43) Pub. Date: Feb. 28, 2019

(54) FLAT BAG STRUCTURE

(71) Applicant: Xiamen Xingyatai Plastic Industry Co., Ltd., Xiamen City (CN)

(72) Inventor: Nantai Chen, Xiamen City (CN)

(21) Appl. No.: 15/691,771

(22) Filed: Aug. 31, 2017

(51) Int. Cl. B65F 1/00; B65D 33/16

(52) U.S. Cl. CPC B65F 1/0006; B65F 2250/114; B65D 33/165

(57) ABSTRACT

A flat bag structure includes a bag body made of a plastic film. An upper portion of the bag body is formed with at least two straps through at least one cut. The cut has two ends, including a head end and a tail end. Through the straps, the mouth of the bag can be tied to a garbage bin when in use, preventing the mouth of the bag from falling off. Through the straps, the mouth of the bag can be tightened and closed. The straps are directly formed on the bag body through the cut. The flat bag can be produced more easily, and the cost is lower.

### BACKGROUND OF THE INVENTION

### 1. Field of the Invention

The present invention relates to a plastic bag, and more particularly to a flat bag structure.

### 2. Description of the Prior Art

In our daily life, we often use garbage bags to contain rubbish. There are various garbage bags on the market, and most of them are flat garbage bags. The flat garbage bag has a simple structure and can be put into mass production with ease and has a low price. The flat garbage bag brings great convenience to our life.

As shown in FIG. 1 and FIG. 2, a conventional flat bag is made of a plastic film. Two sides of the bag are folded inward (as shown in FIG. 1) to form four edgefolds 14, or two sides of the bag are folded outward (as shown in FIG. 2) to form two edgefolds 14. One end of the bag is sealed by means of hot melting. Another end of the bag is an open end. When in use, as shown in FIG. 3, the bag 1′ is expanded, the sealed end of the bag 1′ is placed into a garbage bin 2, and the mouth of the bag is folded outward to be placed on the flange of the garbage bin.

But, in actual use, the mouth of the flat garbage bag is greater than the mouth of the garbage bin. When the flat garbage bag is placed into the garbage bin, the garbage bag is usually very loose. Once the rubbish has a certain weight, the mouth of the garbage bag may fall into the garbage bin. The user needs to tidy the garbage bag frequently, or the rubbish may fall in the garbage bin or outside the garbage bin. Especially, for a public garbage bag used on a street in a densely populated area, the rubbish may scatter on the street if the garbage bag falls from the garbage bin, which is extremely unsanitary and affects the environment and city appearance. The existing solution is to use an additional sealing rope to tie the mouth of the garbage bag. When in use, the mouth of the garbage bag is tightened to the garbage bin through the sealing rope, so that the flat garbage bag won't fall off easily. Although this method can solve the problem, but it is necessary to use additional materials (sealing rope), and the sealing rope is embedded on the mouth of the flat garbage bag. As a result, the production cost is increased, and the difficulty of production is also increased. This is not the most scientific solution.

Accordingly, the inventor of the present invention has devoted himself based on his many years of practical experiences to solve these problems and develop a flat bag structure which can be tied to the flange of the garbage bin conveniently.

### SUMMARY OF THE INVENTION

The primary object of the present invention is to provide a flat bag structure. The mouth of the flat bag can be tied to a garbage bin, thereby preventing the bag from falling off.

In order to achieve the aforesaid object, the flat bag structure of the present invention comprises a bag body made of a plastic film. An upper portion of the bag body is formed with at least two straps through at least one cut. The cut has two ends, including a head end and a tail end.

Preferably, the head end of the cut is located at an edge of a mouth of the bag body, and the tail end of the cut is located on the bag body under the edge of the mouth of the bag body.

Preferably, the tail end of the cut extends to form a fillet.

Alternatively, the head end and the tail end of the cut are located on the bag body under the edge of the mouth of the bag body.

Preferably, the cut has a “Z”-like shape, a “U”-like shape, or an “S”-like shape.

Preferably, the head end and the tail end of the cut each extend to form a fillet, or one of the head end and the tail end of the cut extends to form a fillet.

Preferably, the number of the cut is one, and the cut is to form the two straps.

Preferably, the straps have a strip shape or a hook shape.

Alternatively, the number of the cut is two, and each cut is to form one of the two straps.

Preferably, the bag body has at least one edgefold, and the two cuts are located at left and right sides of the edgefold of the bag body.

Preferably, the two cuts overlap in a vertical direction.

The present invention has the following advantages.

The upper portion of the bag body is formed with at least two straps through at least one cut. It is convenient to tie the mouth of the bag body to a garbage bin, preventing the mouth of the bag body from falling off. Through the straps, the mouth of the bag body can be tightened and closed. The straps are directly formed on the bag body through the cut, without additional material. Therefore, the flat bag of the present invention can be produced more easily, and the cost is lower.

### BRIEF DESCRIPTION OF THE DRAWINGS

FIG. 1 is a schematic view of a conventional flat bag (the two sides of the flat bag are folded inward);

FIG. 2 is a schematic view of a conventional flat bag (the two sides of the flat bag are folded outward);

FIG. 3 is a schematic view of the conventional flat bag when in use;

FIG. 4 is a schematic view of the present invention when in use;

FIG. 5 is another schematic view of the present invention when in use;

FIG. 6 is a schematic view of a first embodiment of the present invention;

FIG. 7 is another schematic view of the first embodiment of the present invention;

FIG. 8 is a schematic view of a second embodiment of the present invention;

FIG. 9 is another schematic view of the second embodiment of the present invention;

FIG. 10 is a further schematic view of the second embodiment of the present invention;

FIG. 11 is a schematic view of a third embodiment of the present invention;

FIG. 12 is another schematic view of the third embodiment of the present invention;

FIG. 13 is a further schematic view of the third embodiment of the present invention;

FIG. 14 is a schematic view of a fourth embodiment of the present invention;

FIG. 15 is another schematic view of the fourth embodiment of the present invention;

FIG. 16 is a schematic view of a fifth embodiment of the present invention;

FIG. 17 is another schematic view of the fifth embodiment of the present invention;

FIG. 18 is a further schematic view of the fifth embodiment of the present invention;

FIG. 19 is a schematic view of a sixth embodiment of the present invention;

FIG. 20 is another schematic view of the sixth embodiment of the present invention; and

FIG. 21 is a further schematic view of the sixth embodiment of the present invention.

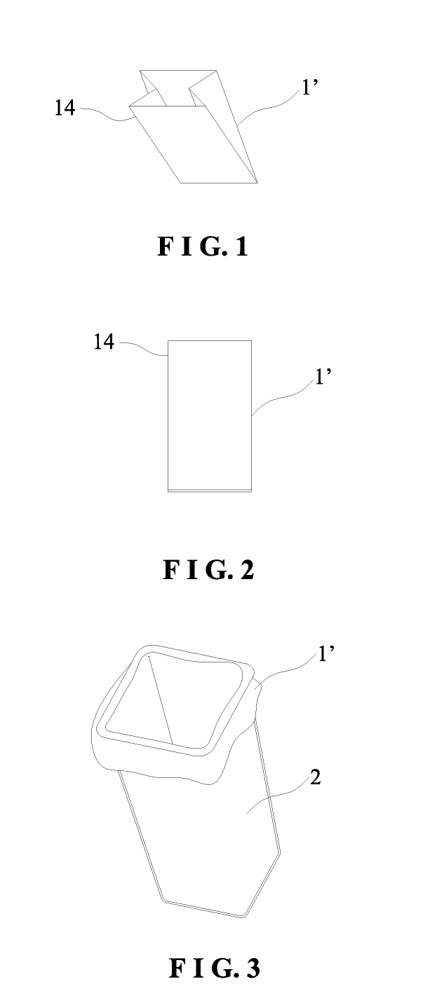

### DETAILED DESCRIPTION OF THE PREFERRED EMBODIMENTS

Embodiments of the present invention will now be described, by way of example only, with reference to the accompanying drawings.

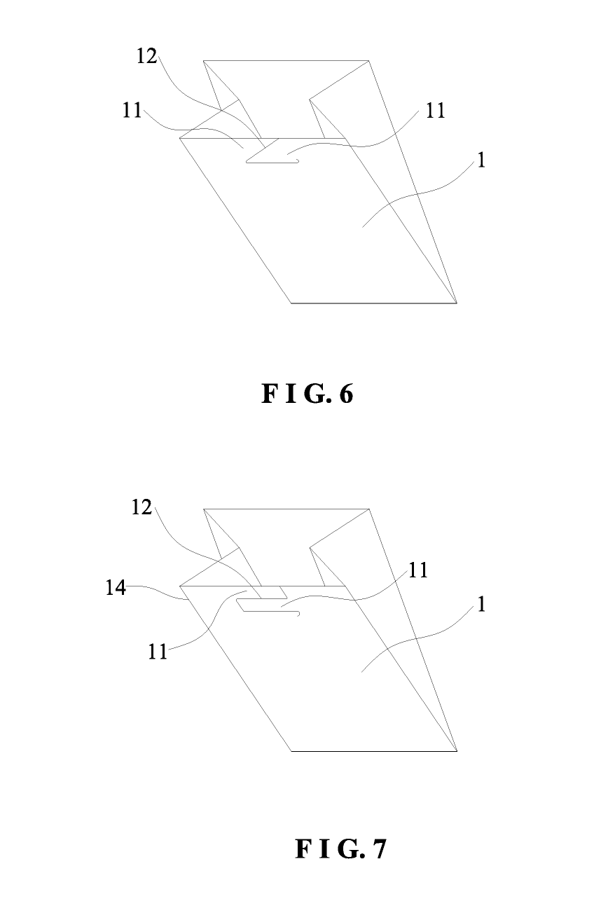

As shown in FIG. 6 to FIG. 21, the present invention discloses a flat bag structure. The flat bag structure comprises a bag body 1 made of a plastic film. An upper end of the bag body 1 is formed with a mouth. A lower end and a circumferential portion of the bag body 1 are closed. Two sides of the circumferential portion of the bag body 1 may be folded inward or outward. The main innovation of the present invention is that the upper portion of the bag body 1 is formed with at least two straps 11 through at least one cut 12. The cut 12 has two ends, including a head end and a tail end. The cut 12 may be a continuous line configuration formed by using a cutter to cut the bag body 1. The cut 12 may be a serrated line configuration which is a tear line formed on the bag body 1. The straps 11 are directly formed on the bag body 1 through the cut 12, without additional material. Therefore, the flat bag of the present invention can be produced more easily, and the cost is lower.

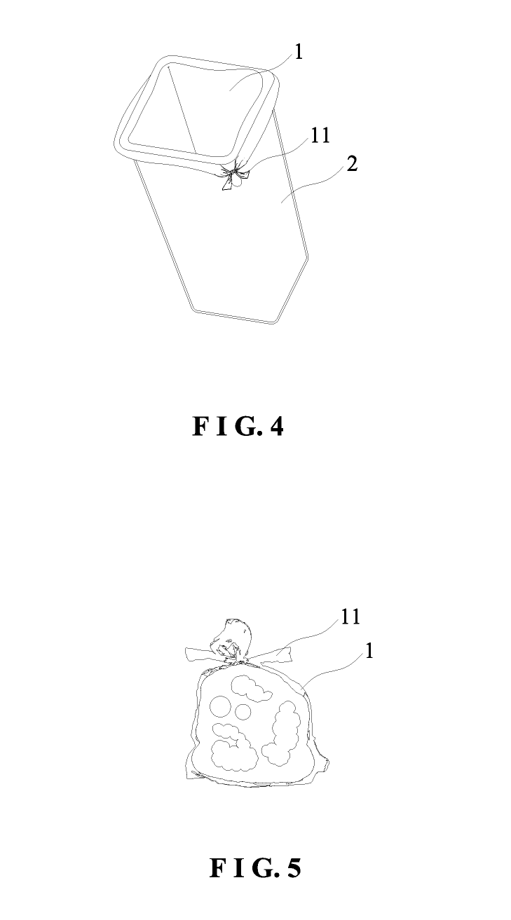

When the present invention is used, as shown in FIG. 4, the bag body 1 is first opened and placed in the garbage bin 2, and the mouth of the bag body 1 is folded outward, and then the mouth of the bag body 1 is bound to the garbage bin 2 through the straps 11, so that the bag body 1 does not fall off during use. There is no need to use an additional sealing rope. As shown in FIG. 5, when the rubbish is full, the straps 11 are released, and then the mouth the bag body 1 can be tied by the straps 11. This not only prevents the rubbish from dropping out of the bag body during transportation but also reduces the smell of rubbish.

The following embodiments specifically illustrate the configuration and formation of the cut 12 and the straps 11.

FIG. 6 and FIG. 7 illustrate a first embodiment of the flat bag structure of the present invention. The upper portion of the bag body 1 is formed with a cut 12. The head end of the cut 12 is located at the edge of the mouth of the bag body 1. The tail end of the cut 12 is located on the bag body 1 under the edge of the mouth of the bag body 1. Through the cut 12, the bag body 1 is formed with two upper and lower strip-shaped straps 11 on the bag body 1. The tail end of the cut 12 may extend to form a fillet to reduce the likelihood of breakage of the strap 11 during the bundling process.

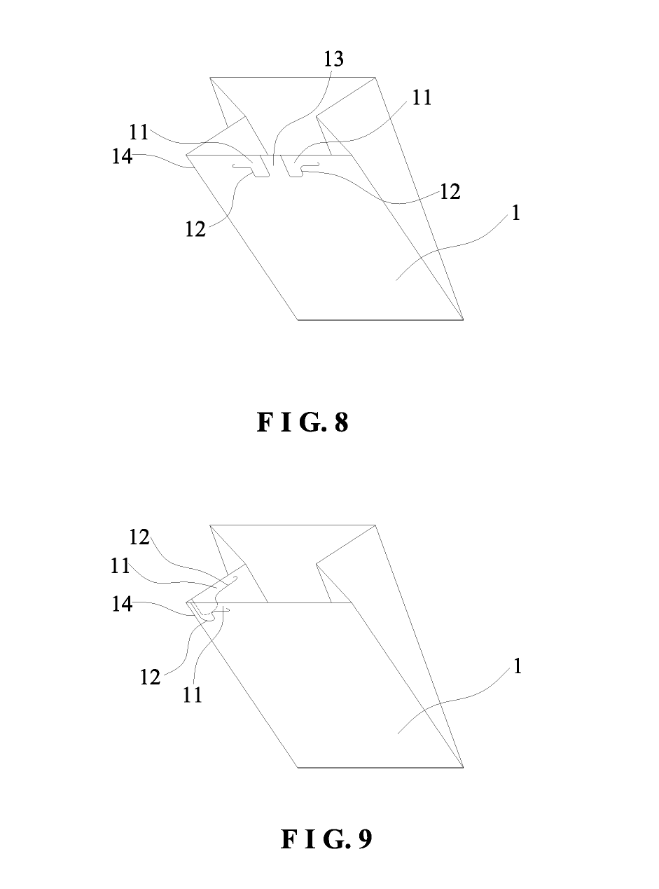

FIG. 8 illustrates a second embodiment of the flat bag structure of the present invention. The upper portion of the bag body 1 is formed with two adjacent cuts 12. The head end of each of the two cuts 12 is located at the edge of the mouth of the bag body 1. The tail end of each of the two cuts 12 is located on the bag body 1 under the edge of the mouth of the bag body 1. Each cut 12 is to form a hook-shaped strap 11. Therefore, the two cuts 12 are to form two hook-shaped straps 11. The tail end of each cut 12 may extend to form a fillet to reduce the likelihood of breakage of the strap 11 during the bundling process. An additional strap 13 is formed between the two cuts 12, and the additional strap 13 may be used to tie the bag body 1 if the length of the additional strap 13 is enough.

In order to facilitate the formation of the cuts 12, the bag body 1 has at least one edgefold 14. As shown in FIG. 9, the two cuts 12 are axially symmetrical. The two cuts 12 are respectively located at two sides of the edgefold 14 of the bag body 1 so that the two cuts 12 which are axially symmetrical about the edgefold 14 may be formed by one cutting. The additional strap 13 includes the upper portion of the edgefold 14.

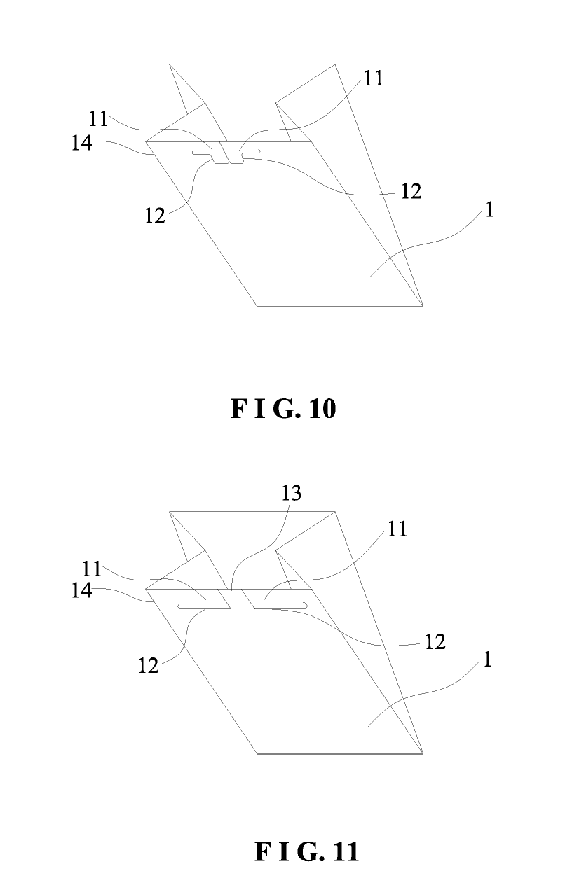

Furthermore, as shown in FIG. 10, the two cuts 12 may overlap in the vertical direction so that there is no additional strap 13 between the two cuts 12, which can prevent the material from being wasted. The two cuts 12 may be formed by a specific tool.

FIG. 11 illustrates a third embodiment of the flat bag structure of the present invention. The upper portion of the bag body 1 is formed with an “L”-like cut 12 and a “┘”-like cut 12. The head end of each of the two cuts 12 is located at the edge of the mouth of the bag body 1. The tail end of each of the two cuts 12 is located on the bag body 1 under the edge of the mouth of the bag body 1. Each cut 12 is to form a strip-shaped strap 11. The tail end of each cut 12 may extend to form a fillet to reduce the likelihood of breakage of the strap 11 during the bundling process. The two cuts 12 don't overlap each other. Through the two cuts 12, the bag body 1 may be formed with two straps 11. An additional strap 13 is formed between the two cuts 12, and the additional strap 13 may be used to tie the bag body 1 if the length of the additional strap 13 is enough.

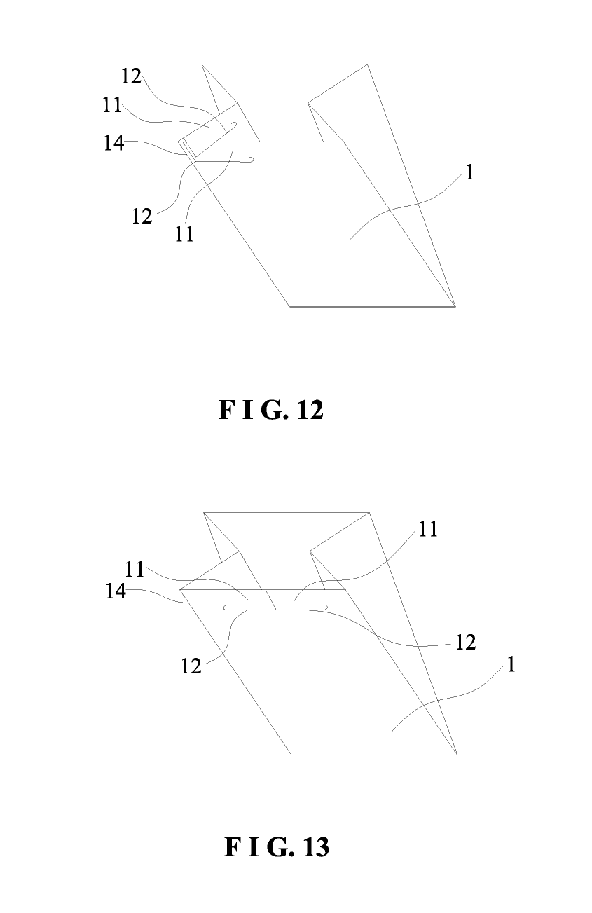

In order to facilitate the formation of the cuts 12, the bag body 1 has at least one edgefold 14. As shown in FIG. 12, the two cuts 12 are located at left and right sides of the edgefold 14 of the bag body 1, so that the two cuts 12 which are axially symmetrical about the edgefold 14 may be formed by one cutting. The additional strap 13 includes the upper portion of the edgefold 14.

Furthermore, as shown in FIG. 13, the two cuts 12 may overlap in the vertical direction, that is, the two cuts 12 may have a “⊥”-like shape so that there is no additional strap 13 between the two cuts 12, which can prevent the material from being wasted. The two cuts 12 may be formed by a specific tool.

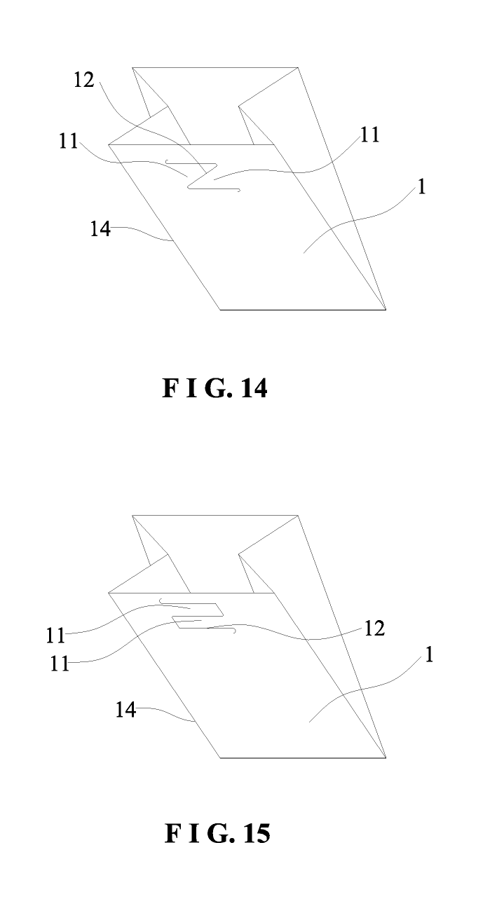

FIG. 14 and FIG. 15 illustrate a fourth embodiment of the flat bag structure of the present invention. The upper portion of the bag body 1 is formed with a cut 12. The head end and the tail end of the cut 12 are located on the bag body 1 under the edge of the mouth of the bag body 1. The cut 12 may have a “Z”-like shape (as shown in FIG. 14) or an “S”-like shape (as shown in FIG. 15). Through the cut 12, the bag body 1 is formed with two upper and lower straps 11 on the bag body 1. The head end and the tail end of the cut 12 each extend to form a fillet, or one of the head end and the tail end of the cut 12 extends to form a fillet to reduce the likelihood of breakage of the strap 11 during the bundling process.

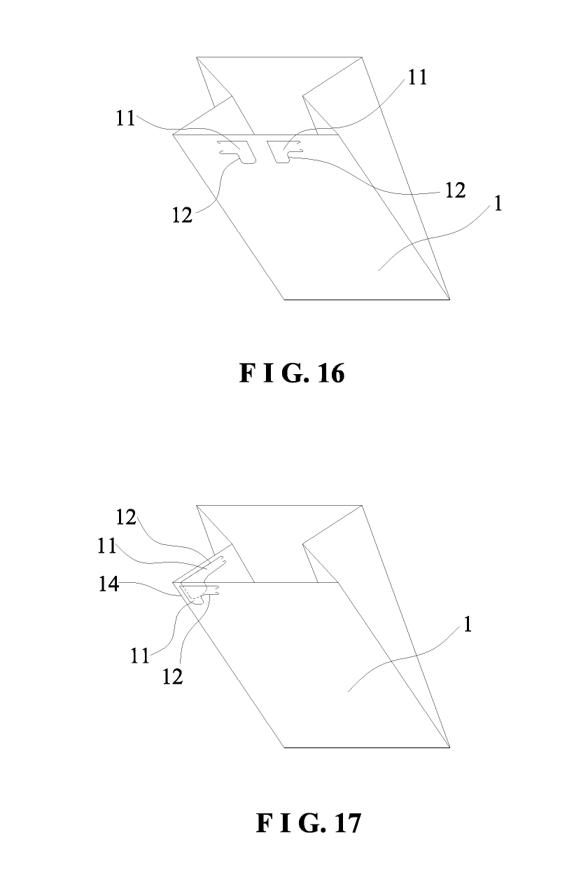

FIG. 16 illustrates a fifth embodiment of the flat bag structure of the present invention. The upper portion of the bag body 1 is formed with two cuts 12. The head ends and the tail ends of the two cuts 12 are located on the bag body 1 under the edge of the mouth of the bag body 1. Each cut 12 is to form a hook-shaped strap 11. An additional strap 13 is formed between the two cuts 12. The head end and the tail end of each cut 12 each extend to form a fillet, or one of the head end and the tail end of each cut 12 extends to form a fillet to reduce the likelihood of breakage of the strap 11 during the bundling process.

In order to facilitate the formation of the cuts 12, the bag body 1 has at least one edgefold 14. As shown in FIG. 17, the two cuts 12 are located at left and right sides of the edgefold 14 of the bag body 1, so that the two cuts 12 which are axially symmetrical about the edgefold 14 may be formed by one cutting.

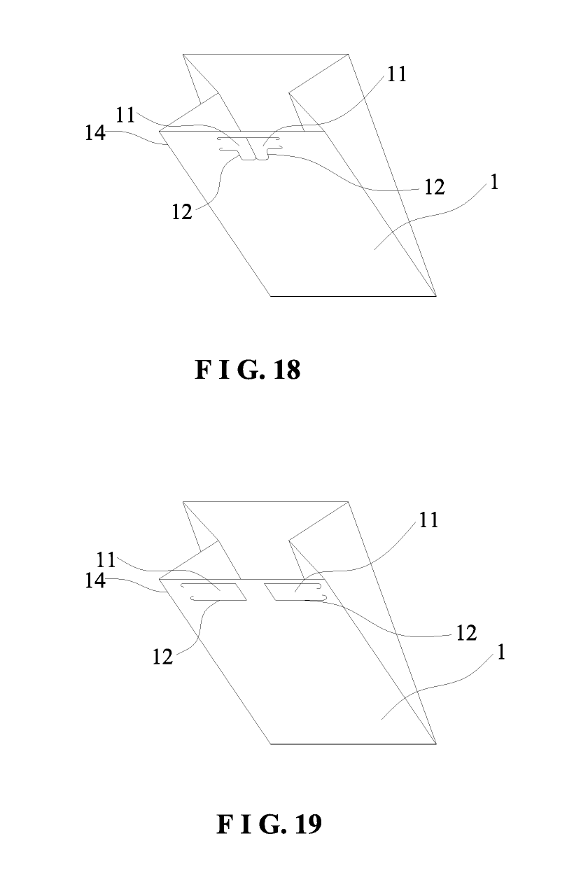

Furthermore, as shown in FIG. 18, the two cuts 12 may overlap in the vertical direction, so that there is no additional strap 13 between the two cuts 12, which can prevent the material from being wasted. The two cuts 12 may be formed by a specific tool.

FIG. 19 illustrates a sixth embodiment of the flat bag structure of the present invention. The upper portion of the bag body 1 is formed with two cuts 12. The head ends and the tail ends of the two cuts 12 are located on the bag body 1 under the edge of the mouth of the bag body 1. The two cuts 12 may have a “U”-like shape. Each cut 12 is to form a strip-shaped strap 11. An additional strap 13 is formed between the two cuts 12. The head end and the tail end of each cut 12 each extend to form a fillet, or one of the head end and the tail end of each cut 12 extends to form a fillet to reduce the likelihood of breakage of the strap 11 during the bundling process.

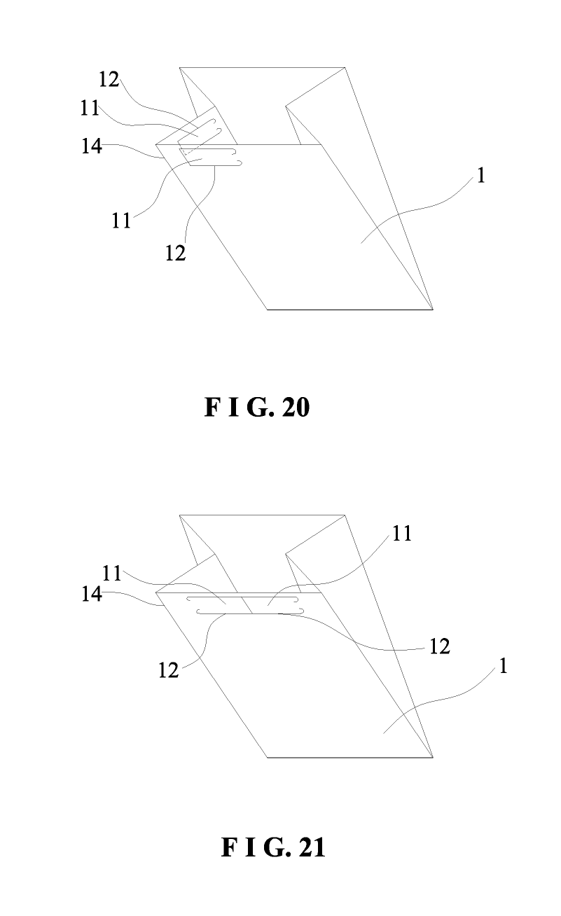

In order to facilitate the formation of the cuts 12, the bag body 1 has at least one edgefold 14. As shown in FIG. 20, the two cuts 12 are located at left and right sides of the edgefold 14 of the bag body 1, so that the two cuts 12 which are axially symmetrical about the edgefold 14 may be formed by one cutting.

Furthermore, as shown in FIG. 21, the two cuts 12 may overlap in the vertical direction, so that there is no additional strap 13 between the two cuts 12, which can prevent the material from being wasted. The two cuts 12 may be formed by a specific tool.

The above-mentioned six embodiments disclose a scheme in which the number of straps 11 is minimized, i.e., the minimum number of cuts 12. The respective embodiments can increase the number of straps 11 by increasing the number of cuts 12.

Although particular embodiments of the present invention have been described in detail for purposes of illustration, various modifications and enhancements may be made without departing from the spirit and scope of the present invention. Accordingly, the present invention is not to be limited except as by the appended claims.

1. A flat bag structure, comprising a bag body made of a plastic film, characterized by: an upper portion of the bag body being formed with at least two straps through at least one cut, the cut having two ends, including a head end and a tail end.

2. The flat bag structure as claimed in claim 1, wherein the head end of the cut is located at an edge of a mouth of the bag body, and the tail end of the cut is located on the bag body under the edge of the mouth of the bag body.

3. The flat bag structure as claimed in claim 2, wherein the tail end of the cut extends to form a fillet.

4. The flat bag structure as claimed in claim 2, wherein the number of the cut is one, and the cut is to form the two straps.

5. The flat bag structure as claimed in claim 2, wherein the straps have a hook shape.

6. The flat bag structure as claimed in claim 2, wherein the number of the cut is two, and each cut is to form one of the two straps.

7. The flat bag structure as claimed in claim 6, wherein the bag body has at least one edgefold, and the two cuts are located at left and right sides of the edgefold of the bag body.

8. The flat bag structure as claimed in claim 6, wherein the two cuts overlap in a vertical direction.

9. The flat bag structure as claimed in claim 1, wherein the head end and the tail end of the cut are located on the bag body under an edge of a mouth of the bag body.

10. The flat bag structure as claimed in claim 9, wherein the cut has a “Z”-like shape, a “U”-like shape, or an “S”-like shape.

11. The flat bag structure as claimed in claim 9, wherein the head end and the tail end of the cut each extend to form a fillet, or one of the head end and the tail end of the cut extends to form a fillet.

12. The flat bag structure as claimed in claim 9, wherein the number of the cut is one, and the cut is to form the two straps.

13. The flat bag structure as claimed in claim 9, wherein the straps have a strip shape or a hook shape.

14. The flat bag structure as claimed in claim 9, wherein the number of the cut is two, and each cut is to form one of the two straps.

15. The flat bag structure as claimed in claim 14, wherein the bag body has at least one edgefold, and the two cuts are located at left and right sides of the edgefold of the bag body.

16. The flat bag structure as claimed in claim 14, wherein the two cuts overlap in a vertical direction.
